(19) United States
(12) Patent Application Publication
(10) Pub. No.: US 2009/0195651 A1
(43) Pub. Date: Aug. 6, 2009

(54) Method of providing safety enforcement for school buses

(76) Inventors: Robert C. Leonard, New Orleans, LA (US); James P. Salande, JR., Mandeville, LA (US); John M. Mamoulides, Metairie, LA (US)

Correspondence Address: Charles E. Frost, Jr.;Chamberlain, Hrdlicka, White,, Williams & Martin, P.C., 1200 Smith Street, Suite 1400, Houston, TX, 77002, US

(21) Appl. No.: 12/012,134

(22) Filed: Jan. 31, 2008

(51) Int. Cl. H04N 7/18

(52) U.S. Cl. 348/148

(57) ABSTRACT

A method for providing for enforcement of school bus safety laws in situations in which a driver of a vehicle near a school bus illegally passes the school bus when it is stopping or stopped and its stop-sign arm is deployed and/or emergency signals are on. The method provides a process for identifying and documenting with live streaming video a violation of school bus safety law as it occurs, documenting and preserving the evidence, presenting the evidence of an alleged violation to law enforcement authorities for determination of whether the case should be pursued, processing a citation or civil assessment to obtain payment of a fine or assessment, providing for the alleged violator to review the video and other evidence of the alleged violation, and providing for the payment of the fine or assessment.

### RELATED APPLICATIONS

None

### COPYRIGHT STATEMENT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to a method for providing enforcement of safety laws concerning school buses in situations in which a driver of a vehicle near a school bus takes actions while driving that violate school bus safety laws and ordinances regarding actions in the near proximity of school buses, such as passing a school bus when it is stopped with its stop-sign deployed and emergency signals on while picking up or discharging riders.

2. Background and Description of Related Art

For many decades, states, counties, and cities have had laws and ordinances to protect the safety of children by making it illegal for a driver of a vehicle to pass, or approach too closely, a school bus while it is stopped on a road with its stop-sign equipment deployed and/or emergency signals flashing. Hereinafter such laws and ordinances will be referred to as “school bus safety laws”. Vehicles on one or both sides of the road are required by most states laws to stop when said school bus is stopped with the stop-sign equipment deployed and/or emergency signals flashing to minimize or eliminate the risk that a student will be struck by a passing vehicle when students are loading or departing a school bus. Drivers of motor vehicles and motorcycles often ignore and violate said laws. Such violations put school children at substantial risk of being injured and/or killed by motorists passing stopped school buses. Such violations are the second or third most egregious violations under many states' laws, and carry substantial penalties, including suspension of a driver's license. The laws are seldom enforced because there are few or no law enforcement personnel available to watch school buses and gather the evidence to cite violating drivers. Furthermore, a school bus driver usually is not in a position to see vehicle drivers violate the school bus safety laws because the driver is generally required to be watching the students departing or entering the school bus—thereby facing the school bus door and away from the left side where the vehicular traffic usually is located. School bus drivers, moreover, do not have time, in addition to performing their primary responsibilities of driving the bus and managing the students, to try to observe and write down the license plate numbers of vehicles violating the school bus safety laws, and then make the requisite reports and pursue the matter.

In addition, many states, counties, and municipalities have laws and ordinances regulating the circumstances under which drivers can pass a school bus while it is still traveling on a road but the emergency equipment has been turned on and the bus is beginning to stop to pick up or discharge students. Drivers of motor vehicles and motorcycles often violate said laws, and sometimes also express hostility as they pass, or approach too closely, the school bus because it is traveling more slowly than the passing driver wishes to travel. Local school administrators and governmental public safety officials have expressed the strong belief to the inventors that such actions put students at great risk; this belief is backed up by surveys of school bus drivers, students, and school administrators. For reasons similar to those expressed above, the school bus safety laws are not being enforced with respect to these types of violations.

Some school districts and/or police departments, in an attempt to reduce the foregoing safety risks, have tried putting public safety officers on school buses or having them follow and observe the school buses while the school buses are on their routes picking up and delivering students. This, however, is expensive and few, if any, school districts and police departments have the funds to pay the personnel, fuel, and vehicle costs or the public safety officers to provide coverage for all, or even a significant portion, of the school buses on a regular basis.

By way of example, a study by the State of Texas indicates that it has a very high number of offenders with a minimal number of prosecutions. A Rhode Island survey of 50 randomly-selected bus drivers found an average of three violations per bus per day—none of which were ticketed. Enforcement is so spotty that in Jefferson Parish, La. (where New Orleans is located), only two tickets were issued in the five years before August 2007 for moving vehicle school bus safety violations.

One response to said problems has been to place an external VCR-type camera on the outside of the bus, and provide control equipment to the bus driver that enables him to activate the camera and capture the illegal activity when he sees a vehicle beginning to pass through his side mirrors. (The pronoun “he” will be used throughout for ease of reference but is intended to include both males and females.) However, there are several difficulties and shortcomings with such a system. First, the bus driver must timely see the violation occurring, which probably will not happen if the bus driver has stopped to unload students—because in many states he is required to look at the students when they are exiting or entering the school bus, if he has unruly students on board, and/or if he is focused on driving the school bus rather than what is occurring with respect to vehicles behind and beside the school bus. Second, the bus driver must remember to activate the system when the violation occurs, and to deactivate it after the violation has occurred; if he does activate it, that activity risks being a distraction from the driver's primary duty of driving safely, and could endanger the students. Third, the bus driver must remember when he has completed his duties of transporting the children to extract and turn in the medium on which the violation has been recorded for processing, and must prepare appropriate documentation, such as an affidavit, and paperwork concerning the incident; if the bus driver is not interested in completing those actions, forgets, or has other duties and responsibilities (such as teaching school), he may fail to provide the evidence and documentation needed for processing and sending a citation to the alleged violator. Fourth, the bus driver may not want to be a witness in a court case. Fifth, a bus driver may not be a good witness, which may result in failure to successfully prosecute violators if they challenge the citation or assessment for the alleged violation. Such a system, therefore, is substantially inadequate for the reliable enforcement of school bus safety laws.

Several patents have been issued providing for various devices and/or systems. To the inventors' knowledge, none have been successfully implemented on a widespread degree, indicating the unsatisfactory nature of such devices and/or methods. Each of these prior recording systems have substantial shortcomings arising from the number of cameras used, the complexity of installation and use; and/or the failure of the systems/methods to result in substantial prosecutions of violations and hoped-for changes in driver behavior.

U.S. Pat. No. 5,382,953 discloses a recording system that includes a sensor positioned on a school bus to detect vehicles violating an extended stop-arm. A camera is mounted on the exterior of the school bus toward its rear facing forwardly. The camera only takes pictures of oncoming vehicles when the sensor, which is mounted at the front end of the bus, detects the oncoming vehicle. A detection mechanism detects the extension of the stop arm on the school bus. A control unit is operable with the sensor and the detection mechanism and provides a control signal for activating the camera upon receipt of signals from the detection mechanism that the stop-arm is extended and the sensor to indicate the presence of a vehicle in the violation zone. The camera then takes still photographs of the violating vehicle while it is adjacent to the school bus. A substantial shortcoming of this and other patented systems/methods addressed below is that there is no record of when or where the violation occurred. Furthermore, someone must physically obtain the film or other storage media from the bus, and a process must be developed for providing satisfactory admissible evidence to sustain a prosecution if a citation were challenged—if that can be done in light of the shortcoming identified in the immediately preceding sentence.

U.S. Pat. No. 5,793,420 discloses a recording system that employs at least two video cameras mounted on each exterior side of a passenger vehicle, such as a school bus, for recording passing traffic as it is adjacent to the school bus. The cameras face either rearwardly or forwardly relative to the school bus to record passing vehicles and to record license plate numbers, respectively. A switching system is used that responds to detectors or a switching signal to determine which of the video cameras is in communication with the video recorder so as to select which view of passing traffic is recorded and displayed on a video screen in the school bus. The bus driver can be provided control over switching to allow him to switch between an interior camera and the external driver's side camera. The primary focus of the system, however, is prevention of vandalism and attacks on the vehicle.

U.S. Pat. No. 5,027,200 teaches a system for providing allegedly enhanced viewing coverage of traffic conditions to the rear and sides of a vehicle using multiple cameras mounted on the exterior of the vehicle in a manner somewhat similar to the video camera system of the '420 patent. The cameras are directed toward a general area in which viewing is desired. Neither the '200 and '420 patent systems provide any means for recording the information in a readily accessible and processable form that makes enforcement of school bus laws efficient, cost-effective, and highly successful.

U.S. Pat. No. 6,738,089 teaches a camera system and method of a video camera mounted on a school bus and a redirecting mechanism in it field of view enabling it to simultaneously record images of both oncoming vehicles forward of the bus and upcoming vehicles rearward of the bus. The video camera records on videotape for access later and simultaneously transmits the images to a monitor for the school bus driver to observe. The '089 patent's system and method have many of the same flaws and shortcomings addressed above, particularly with respect to the utilization and reliance on the school bus driver and the manual retrieval of the recorded videotape.

Said safety problems identified above are a source of substantial concern and frustration for bus drivers, school district and public safety officials. Several school districts, including the fourth largest school district in the United States, and police/sheriff's department have indicated to the Inventors substantial excitement about the invention set forth herein and a need to employ it as soon as possible. They also have stated pleasure with and a need for the additional source of finding arising from the substantial fines and/or assessments to be obtained from violators, which it is expected will pay for the implementation of the program, especially in view of the fact that in many jurisdictions fines or assessments for such moving vehicle school bus safety violations are substantially larger than regular stop-sign and speeding fines.

It is the object of this invention to provide a highly reliable method for identifying and documenting violations of school bus safety laws regarding passing a school bus, and processing the violations through to ultimate payment of a criminal fine or civil assessment in a high percentage of cases in conjunction with the school district and local law enforcement agencies.

It is a further object of this invention to provide a record of accidents involving a school bus or students discharged from the school bus.

### SUMMARY OF THE INVENTION

In brief summary, the invention provides for the enforcement of safety laws regarding school buses using a process for identifying and documenting with live streaming video a violation of school bus safety law(s) as it is occurring, documenting and preserving the evidence, presenting the evidence of an alleged violation to law enforcement authorities for determination of whether it is a case they believe should be pursued, processing a citation or assessment to obtain payment of a fine or assessment, enabling the alleged violator to review the video and other evidence of the alleged violation, and providing for payment of the fine or assessment.

In a preferred embodiment, the method provides school bus safety by (i) emplacing a plurality of video cameras on the left external side of a school bus; (ii) setting the area of coverage of view and the focus of said external video cameras to record vehicles, including license plates, on any lanes of any roads on which said school bus is operated to the extent vehicles traveling in said lanes are prohibited from passing while the school bus is stopping or stopped; (iii) connecting said external video cameras electronically to an on-bus server; (iv) providing a communications transmission device using commercial wireless media or other communications media; (v) providing live streaming video from the video cameras transmitted using a commercial wireless media system or other communications media system to a monitoring station during the time said school bus is transporting, picking up, or discharging students; (vi) providing a trained person to monitor the live streaming video received from a plurality of one to 12 school buses at the monitoring station; (vii) said trained person monitoring the live video; (viii) identifying a potential violation of school bus safety laws; (ix) designating, recording, and archiving portions of said video evidencing a potential violation; (x) identifying the registered owner of the vehicle using an internet search engine to search government and/or public records; (xi) preparing an affidavit or similar instrument reporting the time, place and activities constituting the potential violation, and signing it in front of a notary using a standardized form not later than 24 hours after the potential violation; (xii) selecting and assembling portions of the video showing the potential violation; (xiii) electronically forwarding a copy of the affidavit, assembled video, and photographs of a vehicle and of the license plate to the appropriate law enforcement agency; (xiv) the appropriate law enforcement agency reviewing the video, photographs, and affidavit to determine if a citation should be approved because the actions appear to constitute a violation; (xv) the law enforcement agency designating electronically or in writing that a particular incident is or is not approved for issuance of a citation; (xvi) issuing a citation or civil assessment under the terms of the appropriate ordinance or statute if the incident is approved for ticketing as a violation; (xvii) mailing the citation to the registered owner of the vehicle; (xviii) making a copy of the selected portions of the video showing the violation incident available on an internet site for the vehicle owner to review; (xix) providing a means for the alleged registered owner to pay the fine or assessment; (xx) providing a means for the alleged registered owner to challenge the citation if he claims he is not the owner, the vehicle was stolen, or that he denies he violated the law, in which case the matter proceeds following normal traffic violation court system procedures.

A key aspect of the method is the third-party administration of the process and the systematic approach to the enforcement of the school bus safety laws from the beginning of a violation to the ticketing of the vehicle driver and, if necessary, having evidence sufficient to present in court.

The invention also provides live and/or recorded evidence of a vehicular accident involving the school bus and/or students entering or departing from the school bus if the accident occurs within the area observed by the external video cameras mounted on the school bus.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of the invention and are not to be considered limiting of its scope, as the invention may admit to other equally effective embodiments.

FIG. 1 is a flow diagram illustrating a preferred embodiment of the method for providing school safety enforcement where the violation is by a moving vehicle driver.

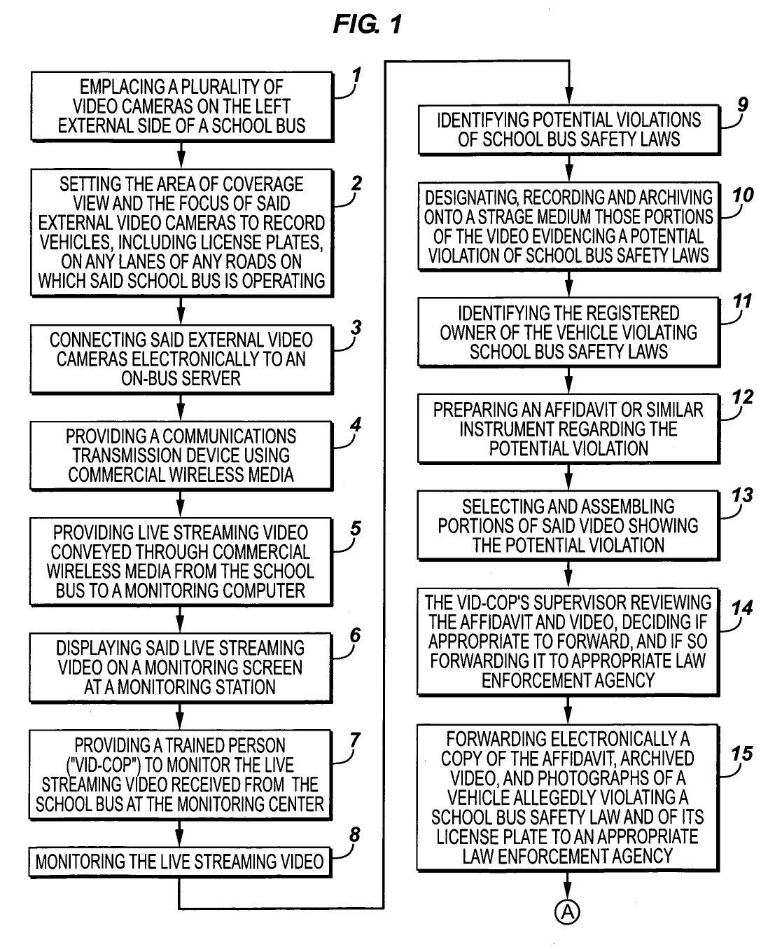

FIG. 2 is a diagrammatic view of a school bus showing the location of the external video cameras and the fields of view in the preferred embodiment.

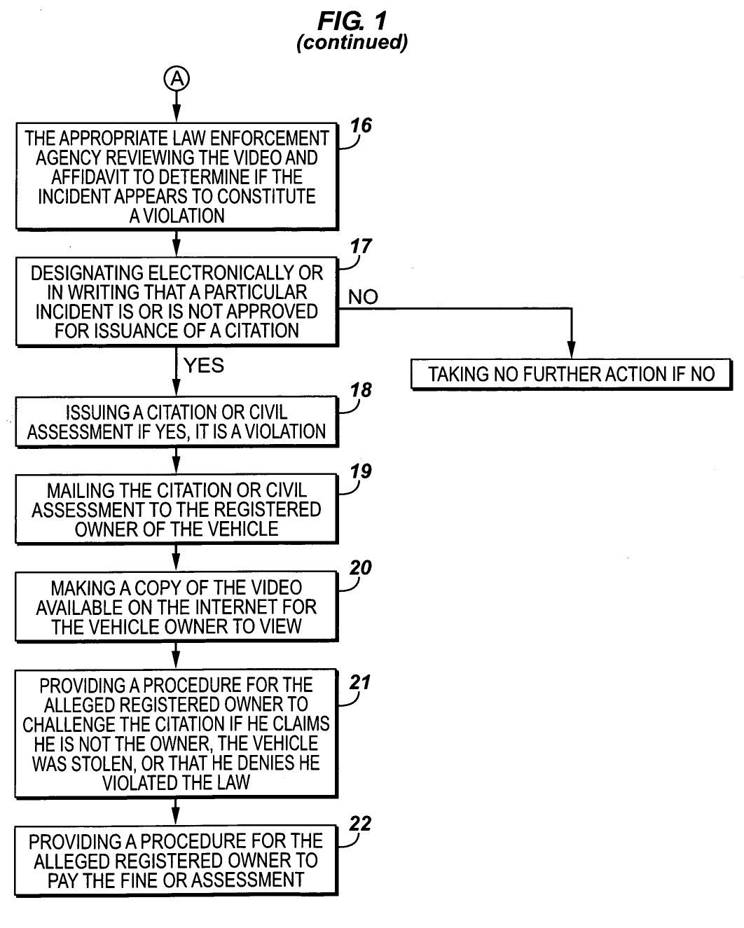

FIG. 3 is a flow diagram illustrating a process for paying the entities involved in the implementation of the method for enforcing the school bus safety laws.

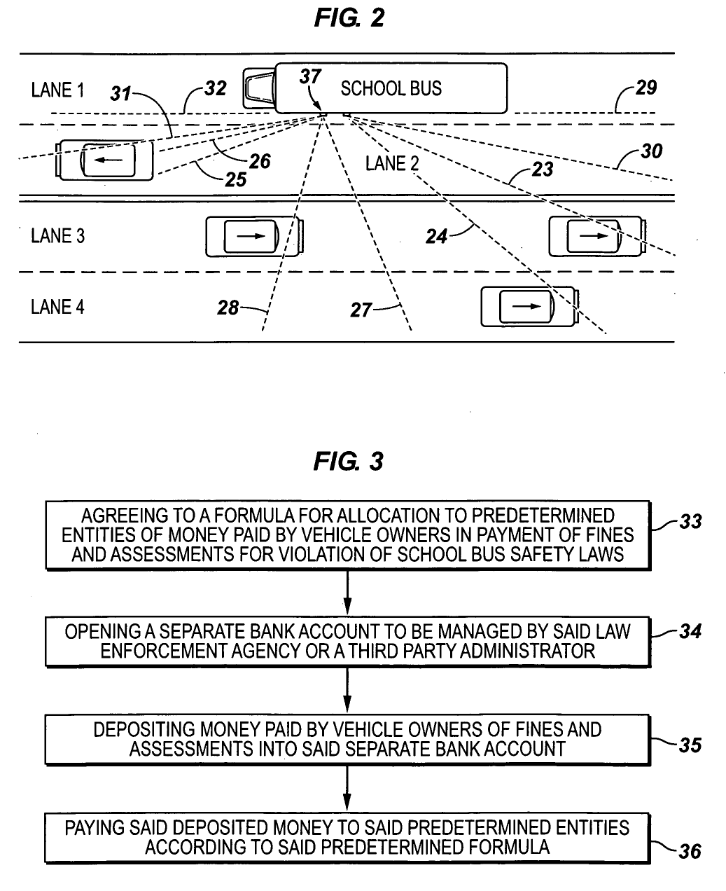

### DETAILED DESCRIPTION OF THE PREFERRED EMBODIMENT(S)

The method is specifically designed to be conducted by either a private contracting company or by a law enforcement agency. The preferred embodiment is that it will be operated by a private contractor. Such a private contractor company will be referred to hereinafter as the “third party administrator”.

A plurality of video cameras are mounted on the left external side of a school bus 1 at any point from about one-fifth of the distance from the front of said school bus to the end of said school bus. In a preferred embodiment, five video cameras are mounted 37 on the left external side of said school bus approximately one-fifth of the distance from the front of said school bus approximately under the school bus driver's and first passenger's windows. The video cameras will hereinafter be referred to as the “external video cameras.” The mounting environmentally seals said external video cameras so that they are protected from the weather elements.

The field of coverage and focus of two of said external video cameras must be set 2 to clearly record images of license plates within any lanes of any roads on which said school bus is operated to the extent vehicles traveling in said lanes are prohibited from passing while the school bus is stopping or stopped. For purposes of this application, the direction the bus is traveling is 0 degrees, the direction perpendicular to the left side of the bus is 270 degrees, and the direction opposite the direction in which the bus is traveling is 180 degrees. The first of said external video cameras is oriented approximately rearwardly and records images in all or part of approximately the range of 195 to 230 degrees; in the preferred embodiment in which the external video cameras are located approximately one-fifth of the distance from the front of the bus, the first external video camera is oriented with a field of view of about 205 23 to 230 24 degrees The second of said external video cameras is oriented approximately forwardly and records images in all or part of approximately the range of 310 to 345 degrees; in the preferred embodiment, it is oriented with a field of view of about 235 25 to 245 26 degrees. Said first and second external video cameras, when hereinafter referred to together, shall be called the “license plate video cameras.” Said license plate video cameras are focused and have a quality of resolution to record with clarity the license plates of motor vehicles on any lanes of any roads on which said school bus is operated to the extent other vehicles are prohibited form passing while said school bus is stopping or stopped. By orienting said license plate video cameras in said manner, and adjusting and setting the focus such that they record clearly and with substantial ease of recognition images of vehicles, including a vehicle's license plate, said license plate video cameras can record images of a vehicle's front and rear as it passes the school bus from either direction, thereby enabling the vehicle license number of any motor vehicle that passes said school bus to be determined readily. The license plate video cameras should have a resolution of at least 380 TVL, where TVL stands for TV Lines; in a preferred embodiment, said license plate video cameras have a resolution of approximately 470 pixels and an adjustable lens with a zoom capability of 4.2 to 42 mm. in order to easily view and determine the license number.

At least one, and in the preferred embodiment three, wide-area external video cameras also are provided. If only one wide-area external video camera is provided, it is oriented approximately perpendicular to the side of the school bus at approximately 270 degrees and with a range of field of view of all or part of approximately 250 to 290 degrees so that it records a picture of the stop sign arm deployed in the stop position and the passing violating vehicle; in the preferred embodiment in which the external cameras are located approximately one-fifth of the distance from the front of the bus, the third external video camera is oriented with a field of view of about 250 27 to 285 28 degrees. This video camera will be referred to as the “stop-sign arm camera.” If two wide area external video cameras are provided, one is said stop-sign arm camera, and the other is oriented to cover and record the area from approximately 180 degrees to 200 degrees; in the preferred embodiment it is oriented with a field of view of about 180 29 to 197 30 degrees. In a preferred embodiment, in addition to the two external video cameras used in the previous embodiment, a fifth of said external video cameras is oriented to face approximately forwardly such that it records images of the area in a range from 340 degrees to 360 degrees; in the preferred embodiment it is oriented with a field of view of about 350 31 to 360 32 degrees.

In an alternate but less preferred embodiment, the fifth external video camera is placed above the windshield of said school bus and is oriented forwardly such that it records about in the range of 340 to 360 degrees. In a further alternate, the fourth external video camera is placed on the back of said school bus and is oriented rearwardly such that it records images about in the range of 180 to 205 degrees.

In a preferred embodiment in which three external video cameras are used, said wide area external video cameras should have an approximately a resolution of at least 380 TVL. Such video cameras may be specially acquired or off-the-shelf video cameras that can be purchased from closed circuit television and/or security equipment providers.

Each of said external video cameras continually record a live real-time video image of the areas in the proximity of the bus on which each camera is focused during the times when the school bus is operating. Each of the external video cameras is electronically connected to a computer server located securely on the school bus 3. Said computer server shall hereafter be referred to as the “on-bus server.” Said connections are standard for someone skilled in the art of emplacing such equipment. The images recorded by said external video cameras are continuously transmitted to said on-bus server 5.

Said external video cameras also are connected electronically to a communications transmission device 4. In a preferred embodiment, the communications transmission device is also part of said on-bus server. Said communications transmission device sends the video in a live streaming mode through a microwave, satellite, or commercial wireless medium to a monitoring station. Said commercial wireless medium can be any medium that will carry internet protocol, including but not limited to wi-fi, radio, and satellite. Said on-bus server also records all images recorded by each of said external video cameras on commercial electronic industry standard data storage media, such as a CD, DVD, external hard-drive, zip drive, or thumb drive.

While the school bus is picking up, transporting, and/or delivering students, live real-time streaming video images from each of said external video cameras are continuously transmitted via commercial wireless media to a monitoring station.

A computer at the monitoring station receives the continuous live streaming video transmissions recorded by said forwardly-looking and rearwardly-looking external video cameras and sent by the on-bus server or other communications transmission device. Said computer at the monitoring station shall hereinafter be referred to as the “monitoring computer.” Said monitoring computer continuously displays the live streaming video from the forwardly-looking and rearwardly-looking external video cameras side-by-side on a dedicated portion of a monitor screen called a “field” 6. In a preferred embodiment, said monitor screen is an approximately 46-inch commercially marketed screen; such screens are sold by retail companies such as WalMart and Sam's Club. As few as two or as many as 12 live steaming videos from an equal number of school buses may be displayed on fields on the monitor screen. In a preferred embodiment, live real-time streaming video from six buses is displayed simultaneously on fields on the monitor screen: one field in an upper left field, one field in an upper right field, one field in a left middle field, one field in a right middle field, one field in a lower left field, and one field in a lower right field.

A main system server, which may be located at the monitoring station or elsewhere, houses the data that records the GPS location of the school bus, records all data entries needed, downloads live streaming video from all external video cameras on all school buses being monitored, obtains school bus identification from the on-bus servers of all school buses being monitored, and performs other functions described hereinafter.

A Global Positioning System (hereinafter “GPS”) also is mounted in the school bus and connected to the live streaming video transmission sent from the school bus. The location of the school bus is reported by the GPS and transmitted to the main system server at the monitoring control station by the aforesaid on-bus server or other communications transmission device.

A trained person is provided at the monitoring station 7 and monitors said live steaming video transmitted from said license plate external video cameras of the school bus 8. Said trained person may be a public safety officer such as a police officer, sheriff's deputy, or constable's deputy. The trained person also may be reserve officers or laymen who are specially trained in school bus safety laws. The term “vid-cops”™ shall be used hereinafter to, refer to such a law enforcement person or other person who monitors the television/computer screens. To be optimally effective, all vid-cops, irrespective of their background, should be well-trained in viewing the live video and identifying potential violations, preserving the relevant video that shows the potential violation, and completing an affidavit or similar document that documents the actions observed.

Said vid-cop™ observes the live streaming video to identify potential violations of the school bus safety laws 9. The vid-cop may be assigned responsibility for monitoring as few as two or as many as 12 school buses. In a preferred embodiment, said vid-cop is assigned six school buses to monitor during the hours when school buses are being operated. If a school district has many school buses, then a plurality of vid-cops can be assigned to monitor a plurality of monitoring screens and monitoring computers.

School buses typically have a system that activates external warning lights and/or a stop-warning sign when the school bus is about to stop. This system will be referred to hereinafter as the “school bus stop-warning system”. In this invention, the on-bus server is electronically connected to the school bus stop-warning system. When the school bus stop-warning system is activated, an electronic signal also is simultaneously sent from the school bus stop-warning system to the on-bus server. Said on-bus server then sends a signal through the commercial wireless medium to the monitoring server, which instructs the video monitoring screen to display an alerting signal on the monitoring screen. In the preferred embodiment, the signal displayed is a red border around the outside edge of the field for that particular school bus for a set period of time of from one-half second to 15 seconds. The signal alerts the vid-cop that he should pay particular attention to that screen.

The monitoring computer also is connected to a keypad having keys with numbers matched to each of the fields on said monitor screen. As an illustration, the upper left field could be numbered #1, and the upper right field could be numbered #2; the keypad would have correlating numbered keys for those two fields.

When a vehicle driver begins to pass a school bus in a manner that appears to the vid-cop, while watching the video monitoring screen, to violate school bus safety laws and therefore be a potential violating incident, the vid-cop immediately presses the key on said keypad corresponding to the field displaying said potential violating incident. Pressing said key on said keypad causes the main system server to upload to it a recorded video image for a specified period of time, such as one minute, from each of the external video cameras during the time when the alleged violation was observed by the vid-cop and all data from the on-bus server regarding the incident, and creates a violation incident file on the main system server for that incident.

The vid-cop or another person working with him identifies the vehicle owner of the allegedly violating vehicle using State records, Lexis-Nexis™, or other data bases 11, and copies—“pastes”—that information into the violation incident file on the main system server for the alleged violation incident. The main system server or another computer has a form for a draft affidavit. The main system server or said other computer automatically inputs the vehicle owner, license plate and vehicle information into the appropriate fields of said draft affidavit for the particular violation incident.

The vid-cop or a person working with him then obtains from the monitoring computer a single frame from the video of the violating vehicle's license plate and a single frame from the video, depending on the number of wide-area external video cameras, showing the allegedly violating vehicle passing the school bus and the stop-arm of the school bus extended in the warning position and saves them to the violation incident file 10.

An affidavit regarding the incident is then prepared 12. In the preferred embodiment, upon instruction the main system server automatically generates a draft affidavit containing certain specified information regarding the incident. Said information input by the main system server automatically includes at a minimum the date, time and GPS location of the school bus at the time of the incident believed to be a violation, the school bus' identification, the allegedly violating vehicle's license plate number, the allegedly violating vehicle's description, and the name of the vid-cop who observed the incident.

The monitoring computer has an option for the vid-cop™ to instruct the computer to also upload video and data for a specified period of time, such as a one-minute period, before and/or after the one minute uploaded as described immediately above. If the incident lasts longer than three minutes, the vid-cop or someone working with him also has the option of physically accessing the on-bus computer and obtain the video stored in the memory of said on-bus computer.

In the preferred embodiment, the on-bus server also designates with hidden “digital watermarks” the date, time, particular camera, and name of computer on the videos from the external video cameras.

The vid-cop or someone working with him extracts a selected short segment, preferably of 10-to-30 seconds, of recorded video image from the external video cameras that most clearly shows the violation incident and saves it to a separate storage medium, such as a CD or DVD, or conveys it via electronic data signal to the main system server to the violation incident file 13.

The vid-cop or someone working with him then presents the draft affidavit to a supervisor at the monitoring station for his review 14. Said supervisor is hereinafter referred to as “the monitoring station supervisor”. The package of the selected portions of the video and two single frames from the video will hereinafter be referred to as the “video violation package.” The monitoring station supervisor reviews the affidavit and, if he chooses, accesses the video violation package and reviews it to confirm that it appears to be an actionable violation of school bus safety laws. If he approves the affidavit and video violation package, the vid-cop signs the affidavit and it is notarized.

In the preferred embodiment, the affidavit is completed within 24 hours after the violation incident occurs.

If the monitoring station supervisor approves of forwarding the violation package, then he, the vid-cop, or a person working with the vid-cop or vid-cop supervisor provides said affidavit, said video violation package, and the full minute or minutes of video from all of the external video cameras on the school bus to the appropriate law enforcement agency or legal authority for review and approval 15. The group of persons constituting appropriate legal authority consists of a county sheriff's office, a municipal police department, a county attorney's office, a district attorney's office, a metropolitan transit authority police department, a constable's office, and a school district police department and any other law enforcement authority. The appropriate law enforcement agency or legal authority hereafter will be referred to as the “law enforcement agency.”

Said violation package can be provided to the law enforcement agency by electronic means or in printed form.

Said law enforcement agency reviews each affidavit and video violation package to determine if a citation, notice of civil assessment, or other notice of alleged violation should be issued 16. The citation, notice of civil assessment, or other notice of alleged violation will hereinafter be referred to as the “citation.” Any alleged violations that the law enforcement agency determines not to prosecute or assess are removed by the law enforcement agency or the vid-cop supervisor from the process.

If the law enforcement agency approves issuance of a citation for the violation incident, it designates approval for issuance of a citation 17. The law enforcement agency or the third-party administrator scans the affidavit concerning the violation incident and uploads it to the main system server to the violation incident file. Said affidavit and the video violation package then are uploaded to a website.

A citation regarding each of the alleged violations that the law enforcement agency determines should be pursued is prepared and printed by the law enforcement agency or anyone they designate to do the work for them, including but not limited to the third-party administrator or a print shop employed by the law enforcement agency or the third-party administrator 18. The citation is or served the vehicle owner of the allegedly violating vehicle as provided by local law and procedure, including by U.S. Mail 19.

“Vehicle owner” as used in this Application means the actual registered owner of the vehicle or any driver of the vehicle who reasonably appears to have authority to operate the vehicle. Vehicle owner also includes a lessee of a motor vehicle rented or leased from a motor vehicle rental or leasing company, but does not include the motor vehicle rental or leasing company itself if the vehicle has been leased or rented from the vehicle rental or leasing company.

The citation, or a document accompanying the notice or citation, provides a website address on the internet that the vehicle owner can access to review the video of his alleged violation, including observing the “watermark” of the date and time 20.

The vehicle owner has options regarding what he can do about the ticket 21. He can pay a criminal penalty or fine or civil assessment. He can challenge the citation or civil assessment and ask for a court hearing or trial. He can claim that he did not own the vehicle at the time of the violation incident, or was not driving the vehicle, or it was stolen and he did not have possession of the vehicle because it was stolen, or that he does not believe the citation or assessment should have been issued to him, he can so indicate on the citation and a sworn affidavit. Upon receiving said affidavit from the alleged vehicle owner, the third-party administrator may issue a citation to the allegedly appropriate party.

A procedure for paying of the fine or assessment also is provided 22. The documentation provided to the vehicle owner includes an instruction that the payment shall be made to a specified mailing address and an envelope pre-addressed with said mailing address. The vehicle owner also is provided with a means for paying the fine or assessment by credit card on the internet if he chooses to pay in that manner, consisting of a standard secure electronic commerce site.

Because school bus safety law violations are so serious, and the tickets frequently are quite expensive, provisions may be made for payment of the fine over time. One form of payment over time requires periodic payment of a specified amount, such as $100 every two weeks, until the fine is paid in full. In one embodiment, the violator is offered an administrative procedure and the opportunity of paying the fine/assessment within a certain period-of-time, and if full payment is made by the deadline, no report is made in the state records and no report is provided to the violator's insurance carrier.

The parties who are involved in the school bus enforcement system agree to an allocation of the monies paid as fines or assessments by vehicle owners 33. The principle purpose of the allocation is to pay the costs of operating the method. A bank account is opened to receive said vehicle owner payments 34. The money received from the vehicle owner is deposited into said bank account managed by the law enforcement agency or the third-party administrator 35. The law enforcement agency or third-party administrator managing the account thereafter pays money from said account to the entities that are to receive the money based on said pre-agreed formula 36. As an illustration, if the method operator has contracted with a school district, a sheriff, and a county government that the school district will receive 88% of the revenues from any money paid by alleged violators, the sheriff receives 12% of said money paid by alleged violators, and the school board operator disburses 75% to the third-party administrator to pay for the costs of the system and operating the method, then periodically as agreed by the four parties to said contract the money in the account shall be distributed in the agreed percentages to each of the four parties' accounts. This has the advantage of avoiding bureaucratic confusion and failure to pay by one government entity to another governmental entity, and providing accountability of the funds received from violators.

If a collision or other vehicular or pedestrian accident, including one involving a child or the school bus, occurs, the invention may provide a record of what happened if the accident occurred within the area of coverage of one or more of said external video cameras. If one or more of said external video cameras record part or all of the events of a vehicular accident involving a child or the school bus, the recorded video can be accessed by remote or local retrieval and made available as evidence.

An advantage of this invention is that the school bus driver need not have any involvement in the process, and therefore can focus his attention on driving the school bus. A second advantage is that the method is highly efficient. A third advantage is that a substantial percentage of violators can be caught violating the law and endangering students.

I/we claim:

1. A method for providing enforcement of school bus safety laws, comprising the steps of:
(i) emplacing a plurality of video cameras on the left external side of a school bus;
(ii) setting the area of coverage of view and the focus of said external video cameras to record vehicles, including license plates, on any lanes of any roads on which said school bus is operated to the extent vehicles traveling in said lanes are prohibited from passing while said school bus is stopping or stopped;
(iii) connecting said external video cameras electronically to an on-bus server;
(iv) providing a communications transmission device using commercial wireless media or other communications media;
(v) providing live streaming video from said external video cameras transmitted using a commercial wireless media system or other communications media system to a computer at a monitoring station during the time said school bus is transporting, picking up, or discharging students;
(vi) displaying said live streaming video on a monitoring screen at the monitoring station;
(vii) providing a trained person to monitor the live streaming video received from a plurality of one to 12 school buses at the monitoring station;
(viii) said trained person monitoring said live streaming video;
(ix) identifying a potential violation of school bus safety laws;
(x) designating, recording, and archiving portions of said video evidencing a potential violation;
(xi) identifying the registered owner of the vehicle using an internet search engine to search government and/or public records;
(xii) preparing an affidavit or similar instrument reporting the time, location and activities constituting the potential violation, and signing it in front of a notary;
(xiii) selecting and assembling portions of said video showing the potential violation; and
(xiv) electronically forwarding a copy of the affidavit, archived video, and photographs of a vehicle allegedly violating a school bus safety law and of its license plate to an appropriate law enforcement agency.

2. The method of claim 1 further comprising the steps of the appropriate law enforcement agency
reviewing the video, photographs, and affidavit to determine if a citation should be approved because the actions appear to constitute a violation; and
designating electronically or in writing that a particular incident is or is not approved for issuance of a citation.

3. The method of claims 2 further comprising the steps of
issuing a citation or civil assessment under the terms of the appropriate ordinance or statute if the incident is approved for ticketing as a violation;
mailing the citation to the registered owner of the vehicle;
making a copy of the selected portions of said video showing the violation incident available for the owner to view on an internet site;
providing a procedure for the alleged registered owner to challenge the citation if he claims he is not the owner, the vehicle was stolen, or he denies he violated the law; and
providing a procedure for the alleged registered owner to pay the fine or assessment.

4. The method of claims 1 or 2 further comprising the steps of
agreeing to a formula for allocation to predetermined entities of money paid by vehicle owners in payment of fines and assessments for violation of school bus safety laws;
opening a separate bank account to be managed by said law enforcement agency or a third party administrator;
depositing money paid by vehicle owners of fines and assessments into said separate bank account; and
paying said deposited money to said predetermined entities according to said predetermined formula.

5. The method of claims 1 or 2 further comprising the step of recording on an on-bus server the images from said external video cameras.

6. The method of claims 1 or 2 wherein one of said external video cameras has a resolution of at least 380 TVL and is oriented to view all or part of the field of view of about in the range of 195 to 230 degrees,
a second of said external video cameras has a resolution of at least 380 TVL and is oriented to view all or part of the field of view of about in the range of 310 to 345 degrees, and
a third of said external video cameras has a resolution of at least 380 TVL and is oriented to view all or part of the field of view of about in the range of 250 to 290 degrees.

7. The method of claims 1 or 2 wherein one of said external video cameras has a resolution of at least 380 TVL and is oriented to view all or part of the field of view of about in the range of 195 to 230 degrees,
a second of said external video cameras has a resolution of at least 380 TVL and is oriented to view all or part of the field of view of about in the range of 310 to 345 degrees,
a third of said external video cameras has a resolution of at least 380 TVL and is oriented to view all or part of the field of view of about in the range of 250 to 290 degrees, and
a fourth of said external video cameras has a resolution of at least 380 TVL and is oriented to view all or part of the field of view of about in the range of 180 to 200 degrees.

8. The method of claims 1 or 2 wherein one of said external video cameras has a resolution of at least 380 TVL and is oriented to view all or part of the field of view of about in the range of 195 to 230 degrees,
a second of said external video cameras has a resolution of at least 380 TVL and is oriented to view all or part of the field of view of about in the range of 310 to 345 degrees,
a third of said external video cameras has a resolution of at least 380 TVL and is oriented to view all or part of the field of view of about in the range of 250 to 290 degrees,
a fourth of said external video cameras has a resolution of at least 380 TVL and is oriented to view all or part of the field of view of about in the range of 180 to 200 degrees, and
a fifth of said external cameras has a resolution of at least 380 TVL and is oriented to view all or part of the field of view of about in the range of 340 to 360 degrees.

9. The method of claims 1 or 2 wherein one of said external video cameras has a resolution of at least 380 TVL and is oriented to view all or part of the field of view of about in the range of 195 to 230 degrees,
a second of said external video cameras has a resolution of at least 380 TVL and is oriented to view all or part of the field of view of about in the range of 310 to 345 degrees,
a third of said external video cameras has a resolution of at least 380 TVL and is oriented to view all or part of the field of view of about in the range of 250 to 290 degrees,
a fourth of said external video cameras has a resolution of at least 380 TVL and is oriented to view all or part of the field of view of about in the range of 180 to 200 degrees, and
a fifth external video camera is emplaced above the front windshield of said school bus, has a resolution of at least 380 TVL and is oriented to view all or part of the field of view of about in the range of 340 to 360 degrees.

10. The method of claims 1 or 2 wherein one of said external video cameras has a resolution of at least 380 TVL and is oriented to view all or part of the field of view of about in the range of 195 to 230 degrees,
a second of said external video cameras has a resolution of at least 380 TVL and is oriented to view all or part of the field of view of about in the range of 310 to 345 degrees,
a third of said external video cameras has a resolution of at least 380 TVL and is oriented to view all or part of the field of view of about in the range of 250 to 290 degrees, and
a fourth of said external video cameras has a resolution of at least 380 TVL, is emplaced on the back of said school bus, and is oriented to view all or part of the field of view of about in the range of 180 to 200 degrees.

11. The method of claims 1 or 2 wherein one of said external video cameras has a resolution of at least 380 TVL and is oriented to view all or part of the field of view of about in the range of 195 to 230 degrees,
a second of said external video cameras has a resolution of at least 380 TVL and is oriented to view all or part of the field of view of about in the range of 310 to 345 degrees,
a third of said external video cameras has a resolution of at least 380 TVL and is oriented to view all or part of the field of view of about in the range of 250 to 290 degrees,
a fourth of said external video cameras has a resolution of at least 380 TVL, is emplaced on the back of said school bus, and is oriented to view all or part of the field of view of about in the range of 180 to 200 degrees, and
a fifth of said external video cameras is emplaced above the front windshield of said school bus, has a resolution of at least 380 TVL, and is oriented to view all or part of the field of vision of about in the range of 340 to 360 degrees.

12. The method of claims 1 or 2 including the further steps of
obtaining the location of the school bus using a Global Positioning System; and
transmitting the location of the school bus to said on-bus server.

13. The method of claim 12 further comprising the step of transmitting the location of said school bus from the GPS to a main system server.

14. The method of claims 1 or 2 further comprising the step of programming said on-bus server to designate with digital watermarks the date, time, and computer on the recorded video image.

15. The method of claims 1 or 2 further comprising the steps of
connecting electronically a school bus stop-warning system on said school bus to said on-bus server;
programming said on-bus server to send a signal to a computer at the monitoring station when the school bus stop-warning system is activated by the school bus driver; and
programming said computer at the monitoring station to display a signal on said monitoring video screen.

16. The method of claim 15 wherein said signal is a red border around the outside edge of the video for said school bus displayed on said monitoring screen for one-half second to 15 seconds.

17. The method of claims 1 or 2 further comprising
providing a computer to assist with monitoring the monitoring screen;
connecting said monitoring computer to said monitoring screen;
connecting said monitoring computer to a main system server;
providing a keypad electronically connected to said monitoring computer;
correlating numbers on the keypad to fields on the monitoring screen showing individual school buses being monitored by said trained person;
programming said main system server to process signals from said keypad to upload specified amounts of recorded video images; and
causing the main system server to upload said recorded video images by pressing the correlated key on said keypad correlated to said school bus when a potential violation of school bus safety laws is observed.

18. The method of claims 1 or 2 further comprising the step of programming a computer to automatically input the desired data for said affidavit into a form of affidavit with specified fields.

19. The method of claims 1 or 2 further comprising the step of extracting a single frame from the recorded video images of a license plate of a vehicle that allegedly has violated a school bus safety law.

20. The method of claims 1 or 2 further comprising the step of extracting a single frame from the recorded video showing a vehicle allegedly passing said school bus when a stop sign arm is extended.

21. The method of claims 1 or 2 further comprising the step of extracting a segment in the range of length of 10 to 30 seconds from one of the recorded video images clearly showing a vehicle allegedly violating a school bus safety law.

22. The method of claims 1 or 2 further comprising the step of completing and signing said affidavit not later than 24 hours after the potential violation incident.

23. The method as in claims 1 or 2 further comprising the step of using a standardized form for the affidavit with selected information to be added by a computer down-loading the data into the standardized form.
